(19) United States
(12) Patent Application Publication
(10) Pub. No.: US 2013/0166763 A1
(43) Pub. Date: Jun. 27, 2013

(54) METHOD AND NETWORK DEVICES FOR SELECTING BETWEEN PRIVATE ADDRESSES AND PUBLIC ADDRESSES WITHIN A USER SESSION

(71) Applicant: Karl Niklas Forsback, Helsinki (FI)

(72) Inventor: Karl Niklas Forsback, Helsinki (FI)

(73) Assignee: NOKIA SIEMENS NETWORKS OY, Espoo (FI)

(21) Appl. No.: 13/820,945

(22) PCT Filed: Sep. 7, 2010
(86) PCT No.: PCT/EP10/63115

§ 371 Date: Mar. 5, 2013

(51) Int. Cl. H04L 29/12

(52) U.S. Cl. CPC H04L 61/256
USPC 709/228

(57) ABSTRACT

According to one aspect of the present invention there is provided a method for selecting a network address within a network. The method may comprise providing network address translation related information of a first user session, storing the network address translation related information of the first user session and selecting a network address for a subsequent second user session by taking into account the network address translation related information of the first user session for the selection.

### TECHNICAL FIELD

The present invention relates generally to mobile communications and more particularly to network devices and methods in communication networks. The invention relates to a method for selecting between private addresses and public addresses within a user session. In addition the invention relates to network devices, to a computer program product and to a computer-readable medium. Moreover, the invention relates to a network comprising a first network device and a second network device.

### BACKGROUND

Networks, in particular communication networks may comprise private addresses and public addresses, in particular private IP addresses and public IP addresses. In communication networks the Internet Protocol version 4 (IPv4) may be utilized. The IPv4 is the fourth revision in the development of the internet protocol (IP) and it is the first version of the protocol to be widely developed within communication networks. The IPv4 is described in IETF publication RFC791 of September 1981, replacing an earlier definition of RFC760 of January 1980. IPv4 is a connectionless protocol for use on packet-switched linked layer networks, in example Ethernet.

IPv4 may use 32-bit (4-byte) addresses which limits the address space available for applications. Some of these addresses are reserved for special purposes such as private networks or for multicast addresses. These reserved addresses may reduce the number of addresses that can potentially be allocated for routing on the public internet. As addresses are being incrementally delegated to end users, an IPv4 address shortage had been observed. However, network addressing architecture redesign as well as network address translation has contributed to delay the IPv4 exhaustion.

In particular, in the mobile packet core network there is a growing need for IPv4 addresses in order to be able to serve the steady growth of new applications provided for user equipment. It is estimated, that IPv4 addresses may be predicted to run out within the next years and operators are interested in methods to utilize existing IPv4 addresses more efficiently.

One tendency is to use IPv6 addresses, which is a version of the internet protocol that is designed to succeed IPv4. IPv6 is specified by the Internet Engineering Task Force (IETF) and described in internet standard document RFC2460, which was published in December 1998. IPv6 has vastly larger address space than IPv4. However, at the moment IPv6 migration may not solve the shortage of IPv4 addresses in a short time view, because a majority of services still use IPv4.

There may be a need to use IPv4 addresses in a more efficient way.

### SUMMARY OF THE INVENTION

According to one aspect of the present invention there may be provided a method for selecting a network address within a network. The method may comprise providing network address translation related information of a first user session. Moreover, the method may comprise storing the network address translation related information of the first user session and selecting a network address for a subsequent second user session by taking into account the network address translation related information of the first user session for the selection.

In order to overcome the IPv4 addresses shortage a network address translation (NAT) may be utilized. Network address translation or NAT may be understood as the process of modifying network address information in datagram packet headers, for example in IP headers. Moreover, in transit across a traffic routing device for the purpose of remapping it may be understood as the process of modifying network address information of one IP address space into another IP address space.

IPv4 addresses may be utilized for the method. The method may utilize address translation related information provided by NAT. The method may add more intelligence to the NAT procedure by introducing a learning mode of the end user network usage. The learning mode may enable the device using NAT in the network to make more optimal decisions based on learned data history from previous user sessions. Thus, information of a previous user session may be utilized in a present user session.

According to an exemplary embodiment of the present invention the first user session and the second user session may be performed by a same user.

Information of a first user session and a second user session may be stored in order to provide historical data of the user for a subsequent user session of that user. Thus, a user behavior may be monitored in order to utilize data of the observed behavior for managing and planning network resources for this user.

According to an exemplary embodiment of the present invention it may be foreseen that the network address translation related information may be at least one information of the group consisting of signaling information, number of ports utilized during a user session, an application protocol, an IP address, a historical data of resource usage, a time duration of usage, a protocol type utilized during the user session, an transmission amount and kind of transferred data.

A private IP address with NAT may be utilized whenever it is possible and a public IP address may be utilized in cases in case there are be service or application specific needs. Additionally the usage of public IPs or public IP addresses may be preferred for some end users. Their network usage behavior may be such that if they are assigned private IPs, the load on the NAT device may be higher than if they are assigned public IPs.

A private network may be a network that uses private IP address space, following the standards set by RFC1918 and RFC4193. These private IP addresses may be commonly used for home, office and enterprise Local Area Networks (LANs), when globally routable addresses may be not mandatory or may be not available for the intended network applications. These addresses are characterized as private, because they may be not globally delegated, meaning they may not be allocated to any specific organization, and IP packets addressed by them may not be transmitted onto the public internet. Anyone may use these addresses without approval from a regional internet registry (RIR). If such a private network needs to connect to the internet, it may use a network address translator, NAT (gateway) or a proxy server.

According to an exemplary embodiment of the present invention it may be foreseen that selecting a network address for the subsequent second user session may be based on a criteria of selecting a private IP address for the second user session when no public IP address was previously utilized in the first user session.

The user may utilize a private IP address as a first choice. The choice of the private IP address may be based on the historical user behavior by utilizing at least a previous session of the user in order to predict the needs before a subsequent session may start. From the past it may be predictable that the user may also have the same behavior and may need only a private IP address for its requested services.

According to an exemplary embodiment of the present invention the method may further comprise utilizing a private IP address in a user session; translating the private IP address into a public IP address within the user session.

In case a public IP address may be necessary due to the services requested by the user, then a public IP address may be provided initially at the beginning of the user session. As an alternative, the user may utilize a private IP address initially and may request a service during the user session which may require a public IP address. In such a case, a translation from a private IP address into a public IP address may take place. The translation may be provided by utilizing NAT. In other words, the user may utilize initially a private IP address and after a translation the user may utilize a public IP address within one session. Providing initially a public IP address or a private IP address may depend on a policy of the operator of the network.

According to an exemplary embodiment of the present invention the method may further comprise allocating IP resources based on the network address translation related information.

An allocation of IP resources for one individual user may provide a further resource control of network resources. From historical user data an operator may know the behavior of the user and may provide only resources as estimated or learned from historical user sessions.

According to an exemplary embodiment of the present invention the method may further comprise providing port ranges of a public IP address for the network address translation.

In computer networking, a port may be an application-specific or process-specific element construct serving as a communications endpoint, providing a multiplexing service. The port may be used by Transport Layer protocols of the Internet Protocol Suite, such as Transmission Control Protocol (TCP) and User Datagram Protocol (UDP). A specific port may be identified by its number, commonly known as the port number, the IP address with which it is associated, and the protocol used for communication.

Transport Layer protocols, such as TCP, UDP, and DCCP, may specify a source and destination port number in their packet headers. A port number may be a 16-bit unsigned integer, thus ranging from 0 to 65535. A process may associate its network input or output channels each with a particular port number, a process known as binding, to send and receive data. The operating system's network may provide transmitting outgoing data from all application ports onto the network, and forwarding arriving network packets to a process by matching the packets IP address and port numbers.

Port ranges may be present within an IP address to be used for the address translation (NAT). One IP address may comprise 65535 port numbers. It may be foreseen to utilize for a first user a port range from 1400-1500 for the actual NAT. A second user may utilize a port range 1501-1600 from the same public IP address. Both users are sharing the port numbers of an IP address, but they are assigned different port number ranges.

According to an exemplary embodiment of the present invention the method may further comprise detecting network usage patterns of an individual user.

A user may show a periodical behavior within the network. For example the user may download data for a video session almost on weekends. Then the operator of the network may know that additional ports or a public IP address for that individual user may be provided especially on the weekend. The additional ports may be allocated from public IPs and may be used for the NAT when the end user is assigned a private IP. Another user may upload data in intervals from time to time, especially in the morning. In such a case the operator of the network may provide additional ports or a public IP address for that user in the morning and on estimated days based on historical data gained by monitoring of the user previously. In these cases the operator may detect network usage patterns or historical data suitable to predict the usage in the future of one individual user. Based on the usage patterns the operator may provide a public IP address or additional ports for an individual user.

For the NAT translation there may be allocated dynamically additional ports for the user or end user if required. The network system may dynamically assign more port ranges from public IPs and may adjust itself to higher network usage conditions. A limitation may be the amount of public IPs being used for the NAT from where the port ranges are allocated.

According to an exemplary embodiment of the present invention the method may further comprise detecting network usage patterns of a user group.

An operator of a network may detect network usage patterns in relation to user groups, for example by analyzing subscriber data of individual users or by monitoring users and observing a common characteristic. One example may be when a plurality of users may watch football over video streaming. The operator may provide further ports or public IP addresses for that event. The estimated resources to be provided by the operator may be based on announced events, on a weather forecast or historical data of the behavior of users. The data on which a network usage may be estimated may originate from the operator data and its monitoring or may originate form outside the network as further information to be taken into account for estimating network usage.

According to an aspect of the present invention there may be provided a first network device comprising a first interface for providing a first connection in a downstream direction towards a user device. Moreover, the first network device may comprise a second interface for providing a second connection in a upstream direction towards a server. Furthermore, the first network device may comprise a packet inspection unit an address translation unit; a sending unit for sending address translation related information to a further network device, wherein the address translation related information is information of an individual user.

A deep packet inspection unit may comprise an end user traffic analysis capability.

According to an aspect of the present invention there may be provided a second network comprising a third interface for providing a third connection in a downstream direction towards a further network device. The second network may further comprise a receiving unit for receiving network address translation related information, a memory for storing the network address translation related information of a first user session, an analyzing unit for analyzing traffic of the first user session utilizing the stored address translation related information and a selection unit for selecting an IP address for the second user session.

According to an exemplary embodiment of the present invention the network device, with other words, the first network device and/or the second network device, may be one of the group consisting of a device for authentication and accounting, a gateway, a GGSN, a SGSN, a server and a radius server.

RADIUS is a protocol which may be used in IP networks, for example, for user authentication and IP address allocation.

The gateway GPRS support node (GGSN) may use the RADIUS protocol to authenticate the user and to get the user IP address from a corporate RADIUS server or radius server. In operator wireless LAN systems, RADIUS may carry user authentication and billing information between the public WLAN access network and the cellular network. A RADIUS server may be a device for authentication and accounting in packet core networks.

According to an aspect of the present invention there may be provided a network comprising the first network device and the second network device, wherein the first network device may be connected with the second network device over the second interface of the first network device and over the third interface of the second network device.

For example, the first network device may be a GGSN. For example, the second network device may be a radius server.

According to a further aspect of the present invention, there may be provided a computer program product comprising code portions for causing a network device, on which the computer program may be executed to carry out a method according to the invention.

According to a further aspect of the present invention, there may be provided a computer-readable medium embodying the computer program product according to the present invention.

The field for application may be mobile packet core networks but the solution may be used elsewhere. The network device may be the GGSN 5 and the policy device may be the radius server 8 in a core environment as shown in FIG. 1. In such an environment the GGSN 5 may have capabilities to analyze end user data and to perform NAT. The method for selecting between private addresses and public addresses within a user session may combine these capabilities with the policy server to be able to make more optimal NAT related decisions.

The policy device or the radius server may be able to learn the traffic behaviour of the end user and may be able in successive sections to take different policy related actions for the actual network address translation process.

It may be foreseen to detect traffic usage patterns and in an intelligent way combine to information to make optimal use of existing IPv4 addresses. The network system may enable the following: a NAT may be utilized for subscribers that do not require a public IPv4 address. Moreover, the NAT translation may use public IP addresses with port ranges. For the NAT translation there may be allocated dynamically more ports for the end user 1 if needed. In addition report to the policy server the network usage pattern may be provided so that the system may know if there is a need for more or less resources in the NAT procedure for the next end user session. Alternatively a report if network usage indicates that NAT may be not suitable may be provided. Moreover, the use of public IPv4 addresses for subscribers may be provided, which subscribers may need these addresses on observed traffic pattern.

There may be provided a solution that offers the possibility to combine network traffic usage intelligence with the NAT procedure. Existing IPv4 addresses may be conserved in an intelligent way, by utilizing network usage patterns and history data of the user 1. Thus, it is foreseen, that the network usage pattern of individual end users 1 may be learned by the network devices and may be allocated and that there may be allocated needed IP resources accordingly. In summary network operators may receive enough IPv4 addresses from the registration authorities in order to provide their services. This means, that the existing address pools may be used more efficiently to secure business operations.

### BRIEF DESCRIPTION OF THE DRAWINGS

Exemplary embodiments of the present invention are described below with reference to the drawings, wherein

FIG. 1 illustrates an exemplary embodiment of a mobile packet core environment; and

FIG. 2 illustrates an exemplary embodiment of a method.

### DETAILED DESCRIPTION

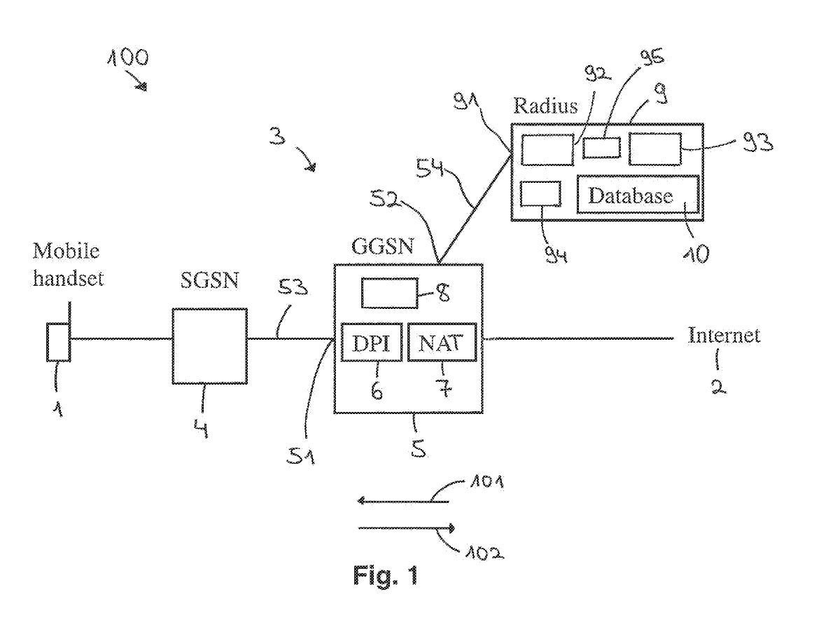

FIG. 1 illustrates an exemplary architecture 100 of a mobile packet core environment. FIG. 1 shows a situation where an end user 1 or mobile terminal 1 or subscriber 1 connects the internet 2 through a mobile network 3, which may be a package core network 3. In the architecture of FIG. 1 the radio access part is not shown but may be added.

The packet core network 3 may comprise network elements or devices. The network 3 may comprise a first network device, such as the GGSN 5 and second network device, such as a subscriber policy capable device, such as a radius server 9. The GGSN 5 may comprise end user data traffic analysis capacity 6 (DPI: Deep Packet Inspection) and NAT functionality 7. The data traffic analysis capability 6 of the GGSN 5 may be utilized to provide NAT related information to a radius server 9. The radius server 9 may be attached to the GGSN 5 and may comprise a database 10 for storing data related to the intelligent NAT functionality. The database 10 in the radius server 9 may utilize the NAT related information provided by the GGSN 5 for successive end user sessions. The radius server 9 may provide NAT related policy decisions based on stored information, for example private IPv4 address or public IPv4 address and an initial amount of port numbers.

Moreover, the radius server 10 may comprise an interface 91 for providing a connection in a downstream direction towards the GGSN 5, a receiving unit 92 for receiving network address translation related information and a memory 93 for storing the network address translation related information of a first user session. Furthermore, the radius server 10 may comprise an analyzing unit 94 for analyzing traffic of the first user session utilizing the stored address translation related information and a selection unit 95 for selecting an IP address for the second user session.

The GGSN 5 may comprise 9 a first interface 51 for providing a connection 53 in a downstream direction 101 towards the user device 1 or mobile handset 1 and a second interface 52 for providing a second connection 54 in an upstream direction 102 towards a server (9). Moreover, the GGSN may comprise a packet inspection unit 6, an address translation unit 7 and a sending unit 8 for sending address translation related information to a further network device 4, wherein the address translation related information is information of an individual user.

The network device GGSN 5 has capabilities to analyze subscriber traffic patterns and network address translation capability. The policy device has storage and analysis capacity for reported traffic data by the network device. The reported data mainly relates to information needed to decide if the subscriber or the user can be assigned a private IP address and how much resources may be needed in terms of network ports. The majority of the end users or subscribers may use private IP addresses which may be then translated to public IP addresses. The system may also be able to identify the part of end users that would need non-translated IP addresses.

A public IPv4 address may be assigned to the mobile terminal 1 by the radius server 8. The end user 1 may exhibit a certain network traffic profile which may identified by the GGSN 5. The end user traffic profile with NAT related information may be reported to the radius server 8. The end user 1 may disconnect and the session of this end user may be ended. The radius server 8 may store this information for successive sessions of this end user 1.

Afterwards the end user 1 may initiate a new session. Then the radius server 8 may assign a NAT related policy for the end user 1 through the GGSN 5. Supported by the NAT policy, the subscriber 1 may be assigned a private IP address. The subscriber private IPv4 address may be translated to a public IPv4 address for external packet data networks. The end user traffic profile may be again followed and reported at the end of the present session.

In addition, the NAT system within the GGSN device 5 may allocate port ranges of public IPv4 addresses per user. These may be legislative requirements to provide NAT binding information for authorities. The use of port ranges per end user 1 may provide it easier to handle the amount of data to be reported. It may be foreseen that from each public IPv4 address a port range may be utilized for dynamic allocation in case the initial port range may be not sufficient.

In summary there may be provided solutions for methods and network apparatus or network devices to add more intelligence to procedures of doing NAT and to introduce a learning mode of the end user network usage. The learning mode may enable the NAT device in the network to make more optimal decisions based on learned data history from previous sessions. This may be done in that way that a gateway may gather statistics of a user equipment traffic patterns. After finishing the session, this statistic data may be reported to an AAA server. When the user equipment establishes a session at a next time the previous traffic pattern statistic may be consulted and based on that information either private or public address may be assigned to the user equipment. This may allow a dynamic way to balance between the pool of public and private IPv4 addresses assigned to the user equipment. The method may provide dynamically make decisions on assigning different classes of IPv4 addresses. More specifically subscribers that based on their internet uses do not need public IPv4 addresses are not given those rather private to be those. They will receive private IP addresses which may be translated by NAT afterwards. The decision may be made each time when the subscriber may establish a connection to the network 3.

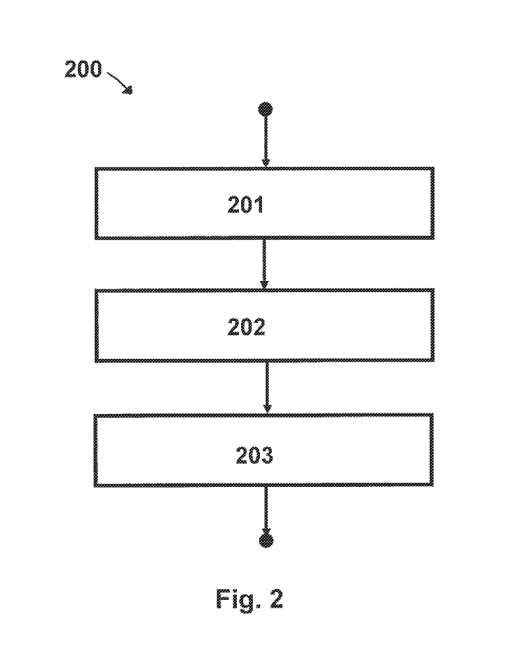

FIG. 2 illustrates an exemplary embodiment of a method 200 according to an aspect of the invention. The method may comprise providing network address translation related information of a first user session, see box 201. The method may further comprise storing the network address translation related information of the first user session, see box 201. Moreover, the method may comprise selecting a network address for a subsequent second user session by taking into account the network address translation related information of the first user session for the selection, see box 203. It may be understood that further boxes or operations may be added.

Exemplary embodiments have been described for 3GPP technology. Similar solutions may be utilized in LTE technology, which is in particular a 3GPP technology, or in similar technologies.

In general, it is to be noted that respective functional elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Furthermore, method steps and functions likely to be implemented as software code portions and being run using a processor at one of the entities are software code independent and can be specified using any known or future developed programming language such as e.g. Java, C++, C, and Assembler. Method steps and/or devices or means likely to be implemented as hardware components at one of the entities are hardware independent and can be implemented using any known or future developed hardware technology or any hybrids of these, such as MOS, CMOS, BiCMOS, ECL, TTL, etc, using for example ASIC components or DSP components, as an example. Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to those skilled in the art.

The network devices or network elements and their functions described herein may be implemented by software, e.g. by a computer program product for a computer, or by hardware. In any case, for executing their respective functions, correspondingly used devices, such as an interworking node or network control element, like an MGCF of an IMS network comprise several means and components (not shown) which are required for control, processing and communication/signaling functionality. Such means may comprise, for example, a processor unit for executing instructions, programs and for processing data, memory means for storing instructions, programs and data, for serving as a work area of the processor and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), interface means for establishing links and/or connections under the control of the processor unit (e.g. wired and wireless interface means, an antenna, etc.) and the like.

For the purpose of the present invention as described herein above, it should be noted that:

an access technology via which signaling is transferred to and from a network element or node may be any technology by means of which a node can access an access network (e.g. via a base station or generally an access node). Any present or future technology, such as WLAN (Wireless Local Access Network), WiMAX (Worldwide Interoperability for Microwave Access), BlueTooth, Infrared, and the like may be used; although the above technologies are mostly wireless access technologies, e.g. in different radio spectra, access technology in the sense of the present invention implies also wirebound technologies, e.g. IP based access technologies like cable networks or fixed lines but also circuit switched access technologies; access technologies may be distinguishable in at least two categories or access domains such as packet switched and circuit switched, but the existence of more than two access domains does not impede the invention being applied thereto,

usable access networks may be any device, apparatus, unit or means by which a station, entity or other user equipment may connect to and/or utilize services offered by the access network; such services include, among others, data and/or (audio-) visual communication, data download etc.;

a user equipment may be any device, apparatus, unit or means by which a system user or subscriber may experience services from an access network, such as a mobile phone, personal digital assistant PDA, or computer;

method steps likely to be implemented as software code portions and being run using a processor at a network element or terminal (as examples of devices, apparatuses and/or modules thereof, or as examples of entities including apparatuses and/or modules therefore), are software code independent and can be specified using any known or future developed programming language as long as the functionality defined by the method steps is preserved;

generally, any method step is suitable to be implemented as software or by hardware without changing the idea of the invention in terms of the functionality implemented;

method steps and/or devices, apparatuses, units or means likely to be implemented as hardware components at a terminal or network element, or any module(s) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;

devices, apparatuses, units or means can be implemented as individual devices, apparatuses, units or means, but this does not exclude that they are implemented in a distributed fashion throughout the system, as long as the functionality of the device, apparatus, unit or means is preserved,

an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;

a device may be regarded as an apparatus or as an assembly of more than one apparatus, whether functionally in cooperation with each other or functionally independently of each other but in a same device housing, for example.

Although described above mainly with respect to methods, procedures, an apparatus and modules thereof, it is to be understood that the present invention also covers a computer program products for implementing such methods or procedures and/or for operating such apparatuses or modules, as well as computer-readable (storage) media for storing such computer program products. The present invention also covers any conceivable combination of method steps and operations described above, and any conceivable combination of nodes, apparatuses and modules described above, as long as the above-described concepts of methodology and structural arrangement are applicable.

Furthermore, the network devices or network elements and their functions described herein may be implemented by software, e.g. by a computer program product for a computer, or by hardware. In any case, for executing their respective functions, correspondingly used devices, such as an interworking node or network control element, like an MGCF of an IMS network comprise several means and components (not shown) which are required for control, processing and communication/signaling functionality. Such means may comprise, for example, a processor unit for executing instructions, programs and for processing data, memory means for storing instructions, programs and data, for serving as a work area of the processor and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), interface means for establishing links and/or connections under the control of the processor unit (e.g. wired and wireless interface means, an antenna, etc.) and the like.

Many modifications and other embodiments of the inventions set forth herein will come to mind to one skilled in the art to which these inventions pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

If desired, the different functions discussed herein may be performed in a different order and/or concurrently with each other. Furthermore, if desired one or more of the above-described functions may be combined.

Although various aspects of the invention are set out in the independent claims, other aspects of the invention comprise other combinations of features from the described embodiments and/or the dependent claims with the feature of the independent claims, and not solely the combination explicitly set out in the claims. It is also noted herein that while the above describes example embodiments of the invention, these descriptions should not be viewed in a limiting sense. Rather there are several variations and modifications which may be made without departing from the scope of the present invention as defined in the appended claims.

In this context, “first”, “second”, etc. in relation to devices or network devices or interfaces may not be understood as hierarchy, it should be understood only to distinguish different devices or interfaces from each other.

It should be noted that reference signs in the claims shall not be construed as limiting the scope of the claims.

### LIST OF ABBREVIATIONS

AAA Authentication, Authorization, Accounting
DPI Deep Packet Inspection
GGSN Packet data gateway in mobile packet core
GPRS General Packet Radio Service
GSM Global System for Mobile Communications
IP Internet Protocol
IPv4 Internet Protocol version 4
IPv6 Internet Protocol version 6
NAT Network Address Translation
RADIUS/radius Remote Authentication Dial-in User Service
SGSN Serving GPRS Support Node
TCP Transmission Control Protocol

### LIST OF REFERENCE SIGNS

1 user device/user equipment/mobile handset/user/end user/subscriber
2 Internet
3 network
4 SGSN
5 GGSN
6 DPI
7 NAT
8 sending unit
9 Radius server
10 database
51 first interface
52 second connection
53 first connection
54 second interface
91 third interface
92 receiving unit
93 memory
94 analyzing unit
95 selection unit
100 architecture
101 downstream
102 upstream
200 method
201 box comprising an operation of a method
202 box comprising an operation of a method
203 box comprising an operation of a method

1. Method for selecting a network address within a network, the method comprises
providing network address translation related information of a first user session;
storing the network address translation related information of the first user session; and
selecting a network address for a subsequent second user session by taking into account the network address translation related information of the first user session for the selection.

2. Method according to claim 1, wherein the first user session and the second user session is performed by a same user.

3. Method according to claim 1, wherein the network address translation related information is at least one information of the group consisting of signaling information, number of ports utilized during a user session, an application protocol, a kind of IP address, a historical data of resource usage, a time duration of usage, a protocol type utilized during the user session, an transmission amount and kind of transferred data.

4. Method according to claim 1, wherein
selecting a network address for the subsequent second user session is based on a criteria of selecting a private IP address for the second user session when no public IP address was previously utilized in the first user session.

5. Method according to claim 1, wherein
the method further comprises utilizing a private IP address in a user session;
translating the private IP address into a public IP address within the user session.

6. Method according to claim 1, wherein
the method further comprises allocating IP resources based on the network address translation related information.

7. Method according to claim 1, wherein
the method further comprises providing port ranges of a public IP address for the network address translation.

8. Method according to claim 1, wherein
the method further comprises detecting network usage patterns of an individual user.

9. Method according to claim 1, wherein
the method further comprises detecting network usage patterns of a user group.

10. A network device comprising
a first interface for providing a first connection in a downstream direction towards a user device;
a second interface for providing a second connection in a upstream direction towards a server;
a packet inspection unit;
an address translation unit; and
a sending unit for sending address translation related information to a further network device, wherein the address translation related information is information of an individual user.

11. A network device comprising
a third interface for providing a third connection in a downstream direction towards a further network device;
a receiving unit for receiving network address translation related information;
a memory for storing the network address translation related information of a first user session;
an analyzing unit for analyzing traffic of the first user session utilizing the stored address translation related information; and
a selection unit for selecting an IP address for the second user session.

12. The network device according to claim 10, wherein the network device is one of the group consisting of a device for authentication and accounting, a gateway, a GGSN, a SGSN, a server and a radius server.

13. A network comprising:
a first network device, according to claim 10, and a second network device comprising a third interface for providing a third connection in a downstream direction towards a further network device;
a receiving unit for receiving network address translation related information;
a memory for storing the network address translation related information of a first user session;
an analyzing unit for analyzing traffic of the first user session utilizing the stored address translation related information; and
a selection unit for selecting an IP address for the second user session,
wherein the first network device is connected with the second network device over the second interface of the first network device and over the third interface of the second network device.

14. Computer program product embodied on a non-transitory computer-readable medium, said computer program product comprising code portions for causing a network device, on which the computer program is executed, to carry out a method according to claim 1.

15. (canceled)
